(19) United States
(12) Patent Application Publication
(10) Pub. No.: US 2003/0157925 A1
(43) Pub. Date: Aug. 21, 2003

(54) Communication unit and method for facilitating prepaid communication services

(76) Inventors: Russell E. Sorber, Oak Park, IL (US); Stacia Kathleen Smith, Chicago, IL (US)

Correspondence Address: MOTOROLA, INC., 1303 EAST ALGONQUIN ROAD, IL01/3RD, SCHAUMBURG, IL, 60196

(21) Appl. No.: 10/079,968

(22) Filed: Feb. 21, 2002

(51) Int. Cl. H04M 11/00

(52) U.S. Cl. 455/406; 379/114.01

(57) ABSTRACT

The present invention addresses the need to facilitate prepaid communication services in a manner that reduces the user inconvenience and lost operator revenue presently associated with account replenishment. The network equipment (110-122) collects service usage information associated with a prepaid account and uses this information to predict when the prepaid account will be depleted. If the remaining time before account depletion is below an established minimum, a communication unit (101) associated with the account is notified. The communication unit is then able to respond by requesting replenishment of the account.

### FIELD OF THE INVENTION

The present invention relates generally to communication systems and, in particular, to facilitating prepaid communication services.

### BACKGROUND OF THE INVENTION

Prepaid wireless service is a growing line of business for cellular operating companies in many places around the world and the predominate line of business in some. However, the method used to replenish or recharge prepaid accounts is inconvenient for subscribers and costs operating companies a growing amount of money. When a user's account unexpectedly expires, the user can be inconvenienced by service discontinuation and the need to recharge the prepaid account before service is resumed. This is costly to operators as well. Users can become frustrated and dissatisfied with the operator, potentially switching to a competing service provider. Also, since no services are provided until the account is recharged, the operator loses revenue from services the subscriber would otherwise use.

Furthermore, such unexpected account expirations can occur even to vigilant users when they use multiple services concurrently or services that are charged at higher rates, such as roaming. Because the prepaid account is being depleted at a faster rate, the user may underestimate how much prepaid time remains. Therefore, a need exists for an invention that facilitates prepaid communication services in a manner that reduces the user inconvenience and lost operator revenue presently associated with account replenishment.

### BRIEF DESCRIPTION OF THE DRAWINGS

FIG. 1 is a block diagram depiction of a communication system in accordance with a preferred embodiment of the present invention.

FIG. 2 is a logic flow diagram of steps executed by a prepaid billing system in accordance with a preferred embodiment of the present invention.

FIG. 3 is a logic flow diagram of steps executed by a communication unit in accordance with a preferred embodiment of the present invention.

### DESCRIPTION OF THE PREFERRED EMBODIMENT

The present invention addresses the need to facilitate prepaid communication services in a manner that reduces the user inconvenience and lost operator revenue presently associated with account replenishment. The network equipment collects service usage information associated with a prepaid account and uses this information to predict when the prepaid account will be depleted. If the remaining time before account depletion is below an established minimum, a communication unit associated with the account is notified. The communication unit is then able to respond by requesting replenishment of the account.

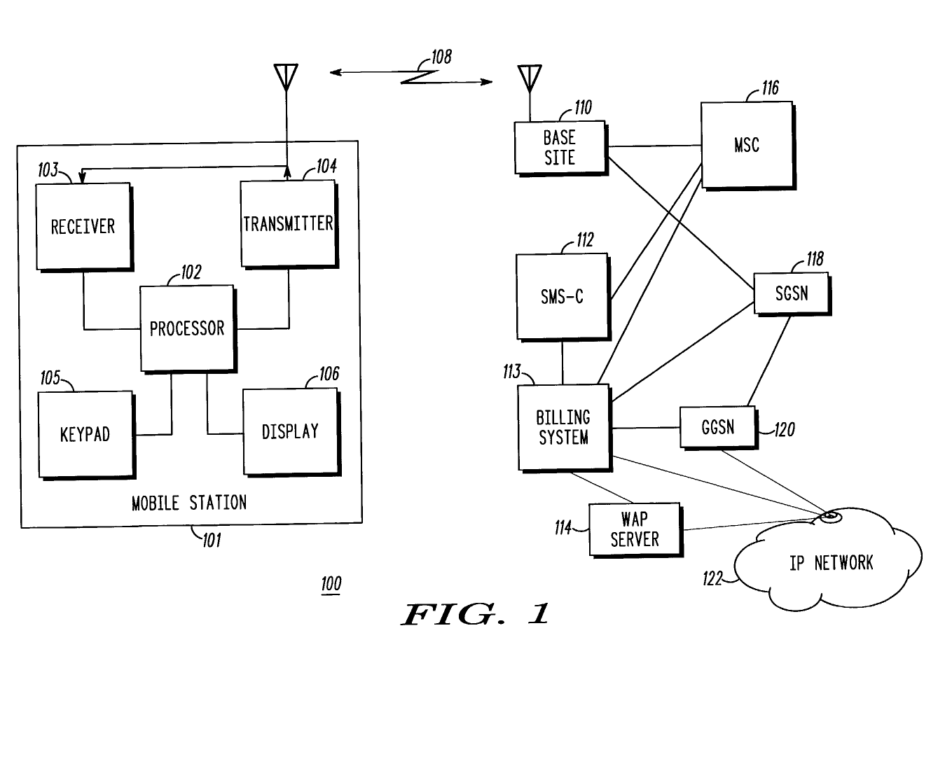

The present invention can be more fully understood with reference to FIGS. 1-3. FIG. 1 is a block diagram depiction of a communication system 100 in accordance with a preferred embodiment of the present invention. Communication system 100 is preferably a well-known General Packet Radio Service (GPRS) system, suitably modified to implement the present invention, but it is not limited to such a system. Alternatively, the present invention may be implemented in communication systems that employ other technologies such as Wideband Code Division Multiple Access (W-CDMA), CDMA2000, Enhanced Data rates for Global Evolution (EDGE), and Universal Mobile Telecommunications System (UMTS).

The preferred embodiment of the present invention includes communication units, such as mobile station (MS) 101, and network equipment, such as devices 110-122. However, the present invention is not limited to communication units that are mobile or wirelessly connected to the network equipment. For example, a communication unit may comprise a desktop computer connected to the network equipment via the Internet.

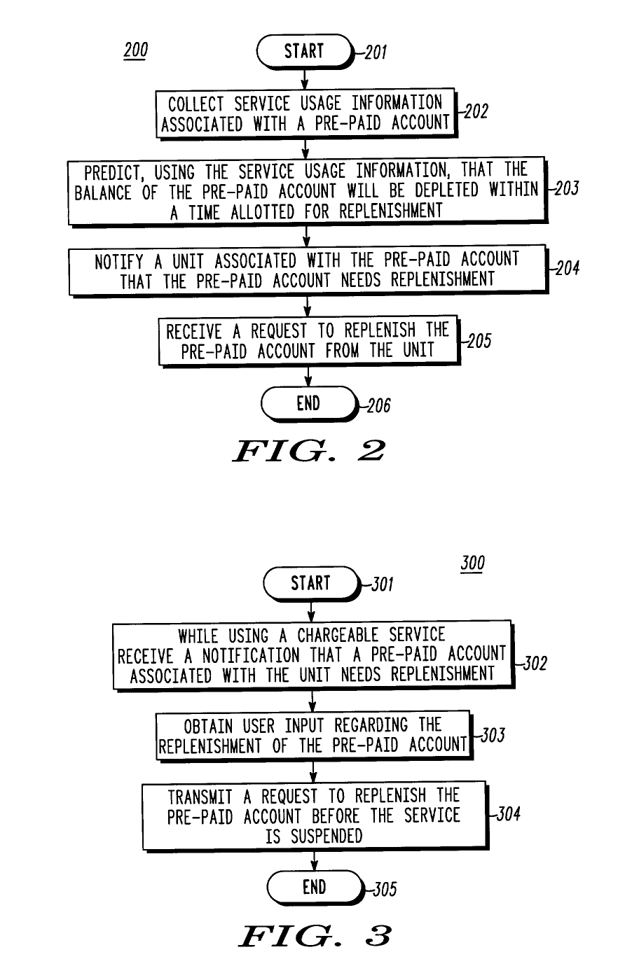

Those skilled in the art will recognize that FIG. 1 does not depict all of the network equipment necessary for preferred system 100 to operate but only those devices particularly relevant to the description of a preferred embodiment of the present invention. As shown in FIG. 1, preferred system 100 comprises well-known devices such as base site 110, mobile switching center (MSC) 116, short message service center (SMS-C) 112, wireless application protocol (WAP) server 114, serving gateway support node (SGSN) 118, gateway GPRS support node (GGSN) 120, internet protocol (IP) network 122, and billing system 113 (which preferably includes a charging gateway function and mediation, rating, and billing devices). In the preferred embodiment, a known GPRS billing system is adapted using known telecommunications design and development techniques to implement the network equipment aspect of the present invention. The result is preferred billing system 113, which preferably performs the method described with respect to FIG. 2. However, those skilled in the art will recognize that the network equipment aspect of the present invention could alternatively be implemented in and across various physical components of system 100.

The network equipment, in particular base site 110, communicates with MS 101 via GPRS air interface resources 108. MS 101 comprises processor 102 (which preferably includes memory and processing devices), receiver 103, transmitter 104, keypad 105, and display 106. Transmitters, receivers, processors, keypads, and displays as used in MSs are all well known in the art. This common set of MS components is adapted using known telecommunications design and development techniques to implement the communication unit aspect of the present invention. Thus modified, preferred MS 101 performs the method described with respect to FIG. 3.

Operation of a preferred communication system 100 in accordance with the present invention, occurs substantially as follows. It is assumed that the user of MS 101 has established and funded a prepaid account with the service operator. This account will be drawn upon to pay for services as they are used. The account need not be associated with a single user nor communication unit. It is envisioned that service operators may allow multiple users using various communication units to charge services to the same prepaid account. For instance, a family may have a single prepaid account with which all services used by family members is associated.

As MS 101 facilitates, or provides its user access to system services, billing system 113 collects service usage information associated with the applicable prepaid account. This service usage information preferably includes updated information on what chargeable services associated with the prepaid account are being utilized. Depending on what services an operator provides, chargeable services for which usage information is collected may include voice, video, music, email, roaming, short message service (SMS), Internet browsing, gaming, sports updates, news updates, traffic updates, weather updates, financial updates, purchasing, shopping, downloadable software, and data.

The service usage information collected is preferably provided to billing system 113 by network components such as MSC 116, SGSN 118, GGSN 120, and via IP network 122, which is preferably connected to the Internet, as is done today in accordance with known protocols. The updated information reflects service events such as initiation, termination, context activation/deactivation, suspension, and service upgrades. Effectively, this updated information is the near real-time information required today to monitor the balance of a prepaid account.

Based on the service usage information, billing system 113 predicts when the prepaid account balance will be depleted. Preferably, this prediction is based on the rate at which each chargeable service associated with the account is presently depleting the account. Different services will likely be charged at different rates by a service operator. Thus, knowing the rate of charge for each service and the near real-time service usage information for each service, billing system 113 can predict when an account associated with these services will be depleted.

When the period of time remaining before account depletion is less than a minimum threshold of time, billing system 113 notifies MS 101 that the account needs replenishment. The account needs replenishment to avoid whatever consequences (e.g., suspension of services) that the service operator implements upon account depletion. In the preferred embodiment, this notification may be sent via WAP server 114, for WAP-enabled MSs, or via SMS-C 112, for any SMS-enabled MS. Also, the minimum threshold of time is preferably a pre-defined, configurable parameter that the system operator can define for all MSs or allow to be individually configurable for each MS.

Thus, receiver 103 receives the notification that a prepaid account associated with MS 101 needs replenishment. MS 101 may receive this notification while continuing to facilitate the use of one or more chargeable services. (It is the use of chargeable services or the reconciliation of chargeable services that would trigger the notification.) Moreover, the notification is preferably received with sufficient time for the user to replenish the prepaid account before the account is depleted. Therefore, the minimum threshold of time or minimum period of time is preferably configured to provide whatever is deemed a sufficient period of time for replenishment. For example, a period of ten minutes might be used.

In the preferred embodiment, the notification may take various forms depending on the chargeable services in use or on the particular attributes associated with the prepaid account. The user may have the account set up to replenish itself by a pre-determined amount simply with his or her authorization. In this case, MS 101 could display the replenishment notice on display 106 and obtain the user's authorization input via keypad 105 in the form of a password, for example. The user may have already provided account information such as a credit card or bank account number to be used for replenishment, or the user may provide this information in response to the notification. Additionally, the user may wish to respond by indicating an amount with which to replenish the account. The amount may be a money amount, such as $30, a money equivalent amount, such as 20,000 frequent flier miles, or an amount related to a particular service, such as 2 hours of talk time or 10 megabytes of data transfer. Alternatively, the user may instruct MS 101 to automatically respond to the notification to avoid being interrupted at all.

Processor 102 responds to the notification by instructing transmitter 104 to transmit to the network equipment a request to replenish the prepaid account. Preferably, this request indicates any input obtained from the user, such as the authorization, authentication, or amount information. MS 101 may transmit this replenishment while continuing to facilitate the use of services. Thus, communication services need not be terminated or suspended during this replenishment notification/request process. This process may be performed concurrently with new and/or ongoing services to prevent service interruption.

Preferably, billing system 113 receives the request to replenish the prepaid account and initiates a transaction to effect the replenishment. The replenishment transaction may take various forms. Examples include charging an amount to a credit card account, charging an amount to a debit card account, transferring an amount from a bank account, and transferring an amount via an online payment system such as “PAYPAL.”

The present invention provides a substantially real-time replenishment solution for prepaid users. By providing an early warning to a user that his or her prepaid account is nearing depletion, the user is able to replenish the account in real-time and thereby avoid service interruptions such as disconnected calls, terminated downloads, or uncompleted purchases. Real-time replenishment via SMS or WAP is much more convenient for a user than having to purchase new prepaid cards or calling the operator, and it can prevent the inconveniences that accompany abrupt service suspension. Moreover, since the present invention provides a real-time network initiated notification together with real-time replenishment, lost operator profits are likely reduced. Users receiving notifications can most easily replenish their prepaid accounts by simply responding at that time. This encourages users to replenish quickly rather than waiting and potentially using alternative communication systems in the interim.

Furthermore, the present invention is an improvement over a number of known methods attempting to address similar prepaid service problems. Today, it is known in the art to provide a low-balance, SMS notification to subscribers at a fixed balance point in the subscriber account. It is also known to provide prepaid balance information to users at the beginning of voice calls and to route depleted prepaid account users to customer service on the first call after the account is depleted. Finally, WAP-based prepaid replenishment is known. The present invention, however, predicts when a balance of the prepaid account will be depleted based on service usage information and sends a network-initiated replenishment notification when the remaining time is below an established minimum. Thus, a user is provided a period of time to replenish his or her account, before the account is depleted, that does not substantially vary with the rate at which the services being used are depleting the account. These known methods, even if taken together, do not provide the present solution.

FIG. 2 is a logic flow diagram of steps executed by a prepaid billing system in accordance with a preferred embodiment of the present invention. Logic flow 200 begins (201) with the billing system collecting (202) service usage information associated with a prepaid account. Using this information, the billing system predicts (203) that the balance of the prepaid account will be depleted within an established minimum period of time. This minimum period of time is preferably an amount of time deemed sufficient for users to replenish the account. Also, in the preferred embodiment, the billing system is re-determining the predicted depletion time for the account as the service usage information is updated. As time passes or increased service usage occurs, the account depletion time can fall within the established minimum.

When this occurs, the billing system notifies (204) a communication unit associated with the account that the account needs replenishment. Preferably, in response to the notification, the billing system receives (205) a request to replenish the account from the unit, and logic flow 200 ends (206).

FIG. 3 is a logic flow diagram of steps executed by a communication unit in accordance with a preferred embodiment of the present invention. Logic flow 300 begins (301) when the communication unit receives (302) a notification that an associated prepaid account needs replenishment. Preferably, the communication unit obtains (303) input from the user regarding replenishment of the prepaid account. The communication unit then transmits (304) a request to replenish the account in accordance with the user input, and logic flow 300 ends (305). Preferably, logic flow 300 is performed by the communication unit while concurrently facilitating new and/or ongoing communications services. Thus, the communication unit user is able to replenish a prepaid account without suffering the suspension or discontinuation of services.

While the present invention has been particularly shown and described with reference to particular embodiments thereof, it will be understood by those skilled in the art that various changes in form and details may be made therein without departing from the spirit and scope of the present invention.

What is claimed is:

1. A method to facilitate prepaid communication services comprising:
collecting service usage information associated with a prepaid account;
predicting that a balance of the prepaid account will be depleted within a period of time based on the service usage information; and
when the period of time is less than a minimum threshold of time, notifying a communication unit associated with the prepaid account that the prepaid account needs replenishment.

2. The method of claim 1 wherein the minimum threshold of time is a pre-defined, configurable parameter.

3. The method of claim 1 wherein the service usage information comprises updated information on what chargeable services associated with the prepaid account are being utilized.

4. The method of claim 3 wherein predicting comprises predicting based on a rate of account depletion for each chargeable service being used and associated with the prepaid account.

5. The method of claim 3 wherein the chargeable services associated with the prepaid account are facilitated by the communication unit.

6. The method of claim 3 wherein the chargeable services associated with the prepaid account are facilitated by a group of communication units collectively.

7. The method of claim 6 wherein the communication unit is a member of the group of communication units.

8. The method of claim 3 wherein the chargeable services comprise a set of services selected from the group consisting of voice, video, music, email, roaming, short message service, Internet browsing, gaming, sports updates, news updates, traffic updates, weather updates, financial updates, purchasing, shopping, downloadable software, and data.

9. The method of claim 1 wherein notifying the communication unit comprises notifying the communication unit via a short message service.

10. The method of claim 1 wherein notifying the communication unit comprises notifying the communication unit via wireless application protocol.

11. The method of claim 1 further comprising receiving a request to replenish the prepaid account.

12. The method of claim 11 wherein the request to replenish indicates an amount with which to replenish the prepaid account.

13. The method of claim 11 further comprising replenishing the prepaid account in a manner selected from the group consisting of charging an amount to a credit card account, charging an amount to a debit card account, transferring an amount from a bank account, and transferring an amount via an online payment system.

14. A method for a communication unit to facilitate prepaid communication services comprising:
receiving, from network equipment, a notification that a prepaid account associated with the communication unit needs replenishment; and
transmitting, to network equipment, a request to replenish the prepaid account.

15. The method of claim 14 wherein the notification is received at a time that is a minimum period of time before a balance of the prepaid account will be predictably depleted, as based on service usage associated with the prepaid account.

16. The method of claim 14 further comprising facilitating the use of at least one chargeable service associated with the prepaid account while receiving the notification and transmitting the request.

17. The method of claim 16 wherein the notification is received at a first time, the request is transmitted at a second time, and the interval between the first time and the second time is sufficient for replenishing the prepaid account while facilitating the use of the at least one chargeable service.

18. The method of claim 14 further comprising obtaining user input that authorizes replenishment of the prepaid account.

19. The method of claim 14 further comprising obtaining user input that indicates an amount with which to replenish the prepaid account.

20. A communication unit comprising:
a receiver adapted to receive from network equipment a notification that a prepaid account associated with the communication unit needs replenishment;
a transmitter; and
a processing unit, coupled to the receiver and the transmitter, adapted to instruct the transmitter to transmit to network equipment a request to replenish the prepaid account.
